(19) United States
(12) Patent Application Publication
(10) Pub. No.: US 2023/0288711 A1
(43) Pub. Date: Sep. 14, 2023

(54) Head-Mounted Display Unit And Head Support Therefor

(71) Applicant: APPLE INC., Cupertino, CA (US)

(72) Inventors: Andrew Gallaher, Sunnyvale, CA (US); Benjamin A. Shaffer, San Jose, CA (US); Julian Jaede, San Jose, CA (US); Samuel G. Smith, San Francisco, CA (US); Trevor J. Ness, Santa Cruz, CA (US)

(21) Appl. No.: 18/125,518

(22) Filed: Mar. 23, 2023

Related U.S. Application Data
(63) Continuation of application No. PCT/US2021/051545, filed on Sep. 22, 2021.
(60) Provisional application No. 63/082,721, filed on Sep. 24, 2020.

(51) Int. Cl. G02B 27/01

(52) U.S. Cl. CPC G02B 27/0176; G02B 2027/0154

(57) ABSTRACT

A head-mounted display includes a display assembly and a head. The head support includes a first hinge portion coupled to a first side of the head-mounted display and a second hinge portion coupled to a second side of the head-mounted display, which are movable between a first and second states. The head support also includes a first elongated portion coupled to the first hinge portion and a second elongated portion coupled to the second hinge portion, which are rigid and movable with the first hinge portion and the second hinge portion, respectively, between the first and second states. A strap portion is flexible, elastic, and extends between the first elongated portion and the second elongated portion. The first elongated portion and the second elongated portion, when in the second state, extend along a rearward side of the display assembly toward each other and do not overlap.

### CROSS-REFERENCE TO RELATED APPLICATION(S)

This application is a continuation of PCT Application No. US2021/051545, filed Sep. 22, 2021, which claims priority to and the benefit of U.S. Provisional Pat. Application No. 63/082,721, filed Sep. 24, 2020, the contents of which are hereby incorporated by reference herein for all purposes.

### TECHNICAL FIELD

This disclosure relates to head-mounted displays and, in particular, head supports therefor.

### BACKGROUND

Head-mounted displays are worn on a head of a user and provide graphical content thereto. Head-mounted displays may include head supports that engage the head of the user when in use but which may be cumbersome when transporting the head-mounted display.

### SUMMARY

Disclosed herein are implementations of head mounted displays and head support therefor. In one implementation, a head-mounted display includes a display assembly and a head support coupled to the display assembly. The head support includes a first hinge portion coupled to a first side of the head-mounted display and a second hinge portion coupled to a second side of the head-mounted display. Each of the first hinge portion and the second hinge portion are movable between a first state and a second state. The head support also includes a first elongated portion coupled to the first hinge portion and a second elongated portion coupled to the second hinge portion. Each of the first elongated portion and the second elongated portion are rigid and movable with the first hinge portion and the second hinge portion, respectively, between the first state and the second state. The head support also includes a strap portion that is flexible, elastic, and extends between the first elongated portion and the second elongated portion. Each of the first elongated portion and the second elongated portion, when in the first state, extend rearward from the head-mounted display and, when in the second state, extend along a rearward side of the display assembly toward each other and do not overlap each other.

In one implementation, a head-mounted display includes a display assembly having an electronic display and a head support coupled for supporting the display assembly on a head of a user. The head support includes first and second hinge portions that each include a tape spring that is movable between a deployed state extending rearward relative the head-mounted display and a stowed state extending laterally across a rearward face of the head-mounted display. The head support also includes a flexible band coupled to the first and second hinge portions.

In one implementation, a head-mounted display includes a display assembly having a chassis and a display coupled to the chassis, a facial support coupled to the display assembly and configured to engage a face of a user for supporting the display assembly thereon, and a head support coupled to the display assembly and configured to engage a head of the user for supporting the display assembly thereon. The head support includes left and right hinges coupled to left and right sides of the chassis of the display assembly. The head support also includes left and right elongated portions coupled to and movable by the left and right hinges, respectively, between extended states and collapsed states. The left and right elongated portions extend rearward relative to the chassis in the extended states and extend laterally across an inner face of the display assembly in the collapsed state. The head support also includes left and right speakers contained within the left and right elongated portions, respectively. The head support also includes audio tunnels contained in the left and right elongated portions that transmit sound from the left and right speakers both forward and rearward thereof. The head support also includes a flexible strap coupled to and extending between the left and right elongated portions.

### BRIEF DESCRIPTION OF THE DRAWINGS

FIG. 1 is a top view of a head-mounted display unit.

FIG. 2 is a schematic of an example hardware configuration of a controller of the head-mounted display unit.

FIG. 3A is a top view of the head-mounted display unit with a head support in an extended state.

FIG. 3B is a top view of the head-mounted display unit with the head support in a collapsed state.

FIG. 3C is a side view of the head-mounted display unit on a head of a user.

FIG. 4A is a partial interior view of a left side of a variation of a head support in an extended state.

FIG. 4B is a partial top view of the left side of the head support of FIG. 4A in the extended state.

FIG. 4C is a partial interior view of the left side of the head support of FIG. 4A in the extended state with various exterior components illustrated in dashed lines and interior components illustrated in solid lines.

FIG. 4D is a partial top view of the left side of the head support of FIG. 4A in the extended state with various exterior components illustrated in dashed lines and interior components illustrated in solid lines.

FIG. 4E is a partial top view of the left side of the head support of FIG. 4A in a collapsed state.

FIG. 4F is a partial top view of the left side of the head support of FIG. 4A in the collapsed state with various exterior components illustrated in dashed lines and interior components illustrated in solid lines.

FIG. 5A is a partial interior view of a left side of another variation of a head support in the extended state.

FIG. 5B is a partial top view of the left side of the head support of FIG. 5A in the extended state.

FIG. 5C is a partial interior view of the left side of the head support of FIG. 5A in the extended state with various exterior components illustrated in dashed lines and interior components illustrated in solid lines.

FIG. 5D is a partial top view of the left side of the head support of FIG. 5A in the extended state with various exterior components illustrated in dashed lines and interior components illustrated in solid lines.

FIG. 5E is a partial top view of the left side of the head support of FIG. 5A in a collapsed state.

FIG. 5F is a partial top view of the left side of the head support of FIG. 5A in the collapsed state with various exterior components illustrated in dashed lines and interior components illustrated in solid lines.

FIG. 5G is a cross-sectional view of the head support taken along line 5G-5G in FIG. 5D.

FIG. 5H is a cross-sectional view of the head support taken along line 5H-5H in FIG. 5F.

### DETAILED DESCRIPTION

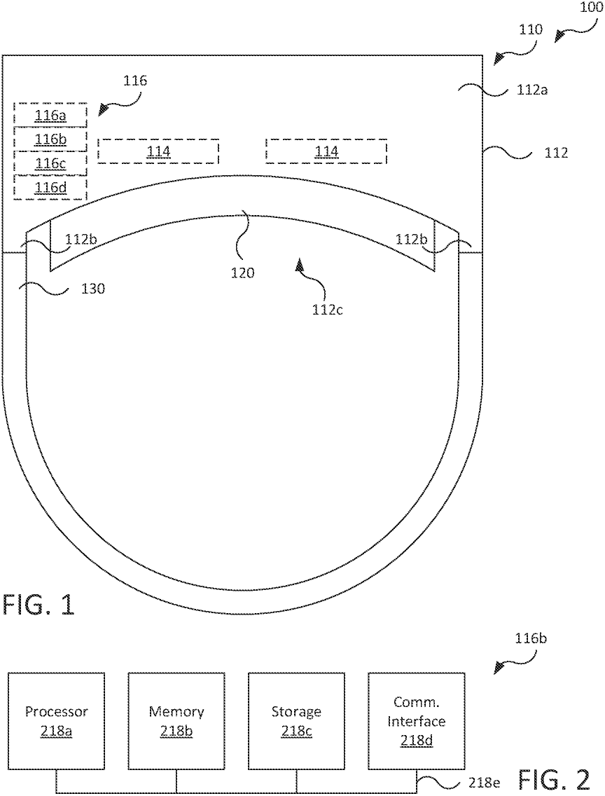

Referring to FIG. 1, a head-mounted display unit 100 generally includes a display assembly 110, a facial interface 120, and a head support 130. The display assembly 110 outputs graphical content to a user wearing the head-mounted display unit 100. The facial interface 120 is coupled to the display assembly 110 and engages the face of the user to support and position the display assembly 110 thereon. The head support 130 is coupled to the display assembly 110 and extends rearward thereof to engage the head of the user, for example, extending therearound, to further support and secure the display assembly 110 to the user.

The display assembly 110 generally includes a chassis 112 and one or more displays 114 that are coupled to and supported by the chassis 112. The chassis 112 is a generally rigid structure that includes a front portion 112a and side portions 112b are coupled to and extend rearward from the front portion 112a. The chassis 112 may include or otherwise be configured as a housing that contains the displays 114 and/or other components and may be referred to as a housing. The chassis 112 may further be referred to as a frame.

The front portion 112a of the chassis 112 is sized to extend across the widths of faces of different users. The side portions 112b are spaced apart so as to accommodate the widths of the faces of the different users therebetween, for example, being spaced apart outward of eyes of the users. The front portion 112a and the side portions 112b may be considered to cooperatively define a recess that accommodates the head of the user. A rearward side 112c of the chassis 112 faces toward the user. The chassis 112, being generally rigid, generally does not bend or otherwise deform in response to normal levels of loading during typical use (e.g., wearing when seated) of the head-mounted display unit 100. The chassis 112 may be formed from one or more components that are coupled to each other to form the rigid structure thereof.

The one or more displays 114 are coupled to the chassis 112, so as to be viewable by a user wearing the head-mounted display unit 100. The one or more electronic displays 114 may be any suitable type of display, such as liquid crystal (LCD), light-emitting diode (LED), micro-LED, or organic light-emitting diode (OLED). The electronic displays 114 may be opaque so as to obstruct the user’s view of the environment, or may be transparent to permit the user to view the environment therethrough. The displays 114 may be further considered to include optical components (e.g., lenses) through which the user views the electronic displays 114.

The display assembly 110 may further include other electronics 116 (depicted schematically), such as a power source 116a, a controller 116b, sensors 116c, and input/output interfaces 116d, among others. The power source 116a may be any suitable power source, such as a battery that stores energy or a plug or cord by which power is transferred to the display assembly 110 from another source. The controller 116b is configured to control operations of the display assembly 110, for example, by operating the displays 114 to output computer generated content. An example hardware configuration of the controller 116b is discussed below with respect to FIG. 2. The sensors 116c may be configured to monitor the user, the environment, and/or the head-mounted display unit 100 and may, for example, include various optical sensors (e.g., visible light cameras, infrared cameras, structured light sensors), ultrasonic sensors, movement sensors (e.g., global position sensors, accelerometers, and/or gyroscopes), audio sensors (e.g., microphones), and physiological sensors (e.g., heart rate, galvanic skin response, electrodes). The input/output interfaces 116d are configured to send and/or receive information from other devices through wired and/or wireless connections, for example, to operate the head-mounted display unit 100 (e.g., user inputs, sensor inputs, software instructions, external communications, and/or content).

Referring to FIG. 2, an example hardware configuration for the controller 116b is illustrated. The controller 116b is any suitable computing device or system capable of implementing the apparatuses and methods described herein. The controller 116b generally includes a processor 218a, a memory 218b, a storage 218c, a communications interface 218d, and a bus 218e by which the other components of the controller 116b are in communication with each other. The processor 218a may be any suitable processing device, such as a central processing unit, capable of executing written instructions (e.g., software programming). The memory 218b is a volatile, high-speed memory device, such as random-access memory. The storage 218c is a non-volatile storage device capable of storing various instructions (e.g., software programming) to be executed by the processor 218a and/or other data, such as a solid-state disk drive. The communications interface 218d is configured to send and/or receive various signals to and/or from the controller, for example, to control the various other electronic components (e.g., the displays 114 and/or the other electronics 116) of the display assembly or electronics of the head support 130 (as discussed in further detail below).

Referring again to FIG. 1, the facial interface 120 is coupled to the display assembly 110 and is configured to engage the face of the user to support and position the display assembly 110 thereon. The facial interface 120 is a compliant structure that, when pressed against the face of the user, compresses or otherwise deforms to conform to the shape of the face of the user and distribute force thereover. The facial interface 120 may, for example, include or be formed of a foam material and/or include suitable mechanisms (e.g., spring linkages). The facial interface 120 may also function to block environmental light from reaching the eyes of the user by engaging the face of the user substantially continuously around the eyes of the user and, as such, may also be considered to be or include a light seal.

The head support 130 functions to physically support the display assembly 110 on the face of the user and may further perform various electronic functions (e.g., sensing, audio transfer, power storage and/or transfer). The head support 130 is mechanically coupled to each of left and right sides of the display assembly 110, for example, being coupled directly to the side portions 112b of the chassis 112 (as shown). Alternatively, the head support 130 may be coupled indirectly to the display assembly 110, for example, being coupled to the facial interface 120 that is in turn coupled to the display assembly 110. The head support 130 is configured to extend around the head of the user to be in tension and pull the display assembly 110 toward the face of the user to compress the facial interface 120 therebetween. The head support 130 may also be electrically coupled to one or both of the side portions 112b of the chassis 112 of the display assembly 110 to transfer signals and/or power therebetween to perform various power functions with the head support 130 (e.g., sound output, sensing, and/or power storage). The mechanical and/or electrical connections between the display assembly 110 and the head support 130 may be generally fixed, such that the head support 130 is not easily removably or connectible by an ordinary user, or may be interchangeable, such that a user may easily connect different ones of the head supports 130 to the display assembly 110 (e.g., with different functions, sizes, or other configurations to accommodate different uses and/or users). Various different aspects and functions of the head support 130 are discussed in further detail below.

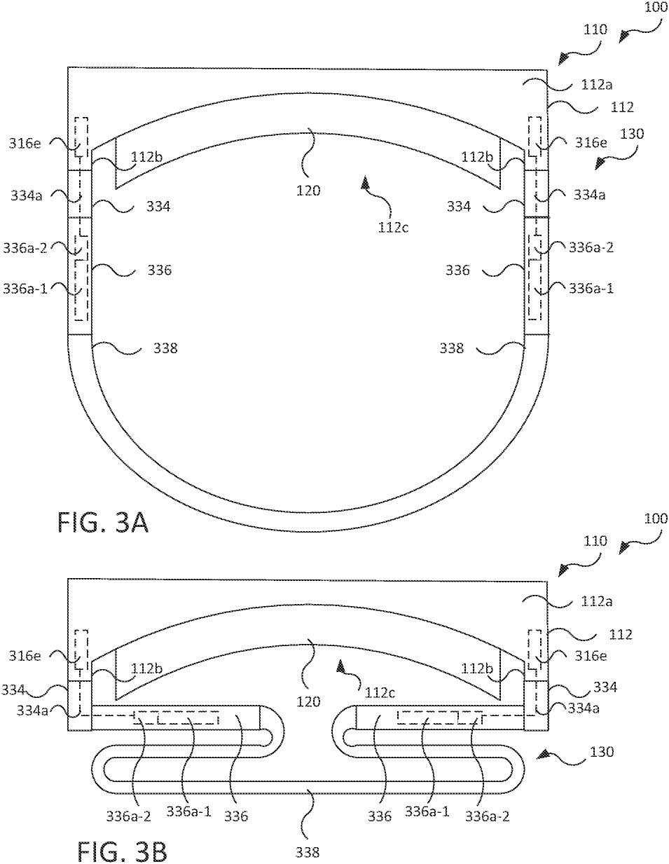

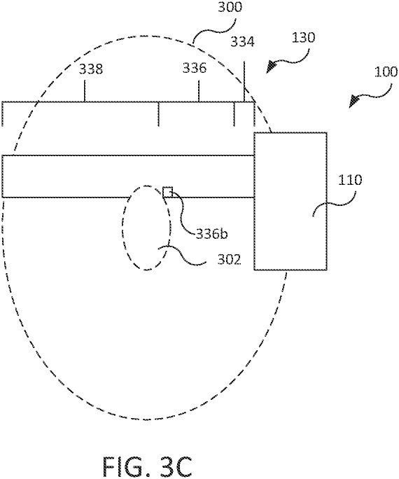

Referring to FIGS. 3A-3B, the head support 130 generally includes, moving rearward from the display assembly 110, two hinge portions 334, two elongated portions 336, and a strap portion 338 extending between the elongated portions 336. In the discussion below and the claims, components of like function or name may be distinguished numerically (e.g., first and second), directionally (e.g., corresponding to left and right sides of the head-mounted display unit 100), or in other manners.

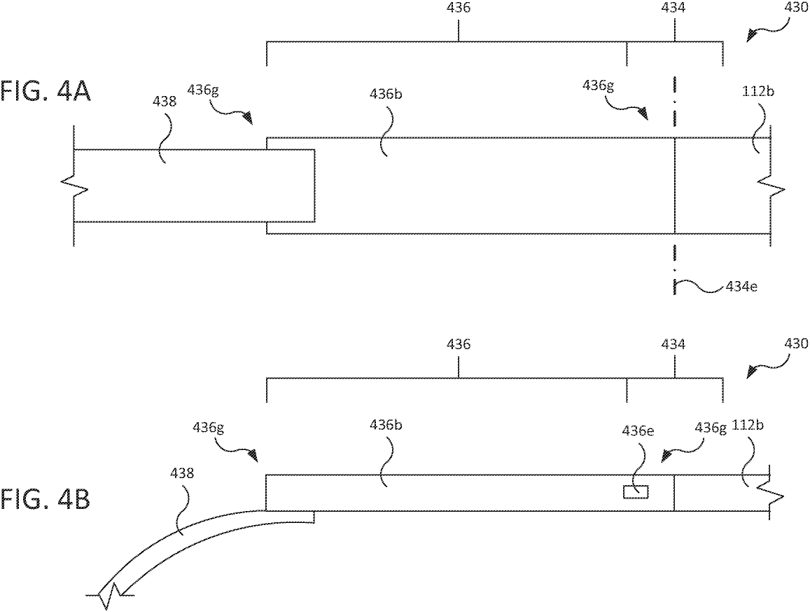

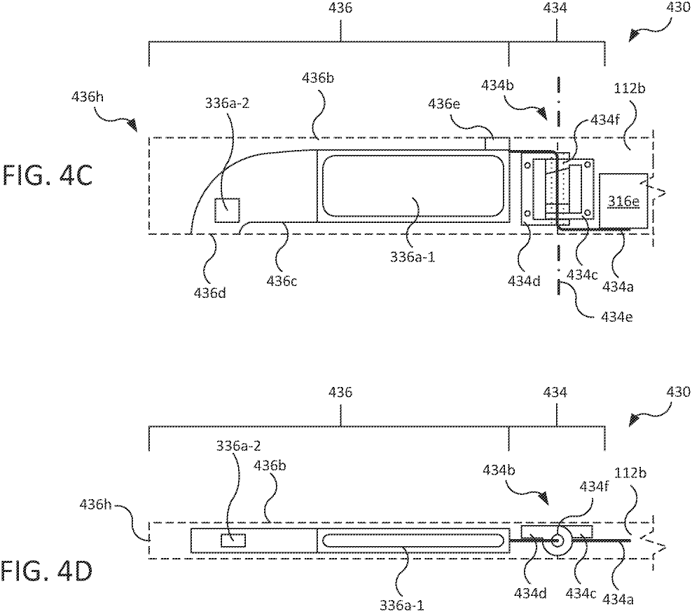

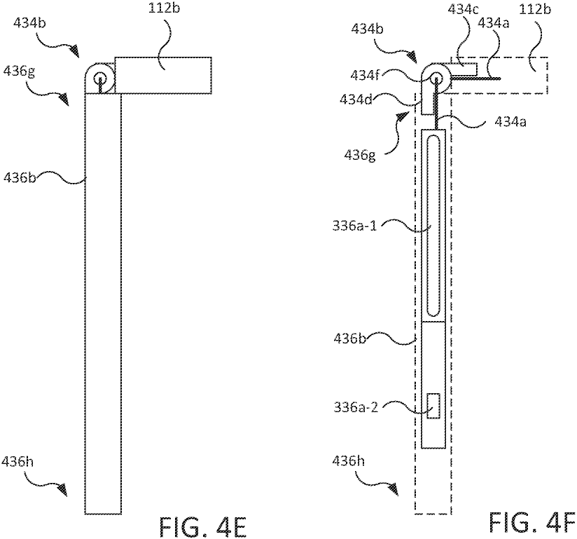

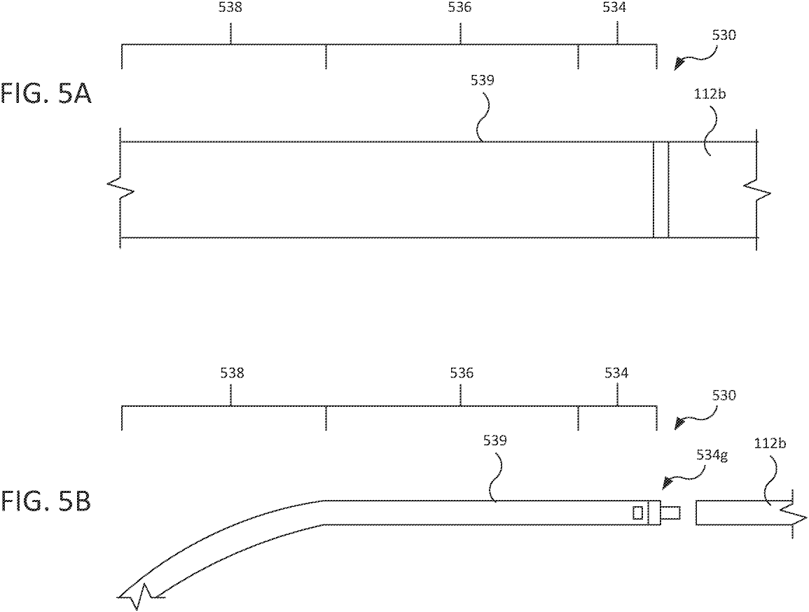

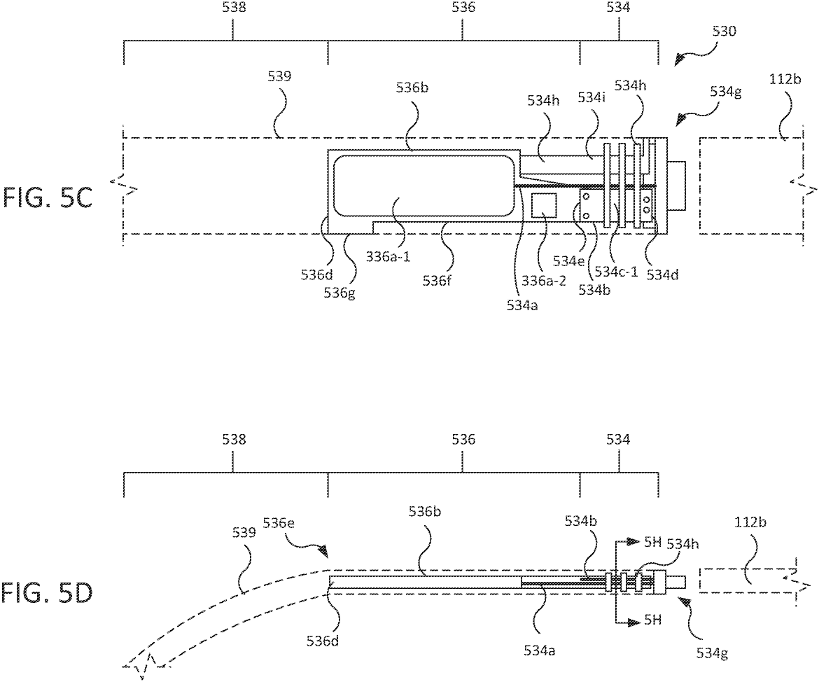

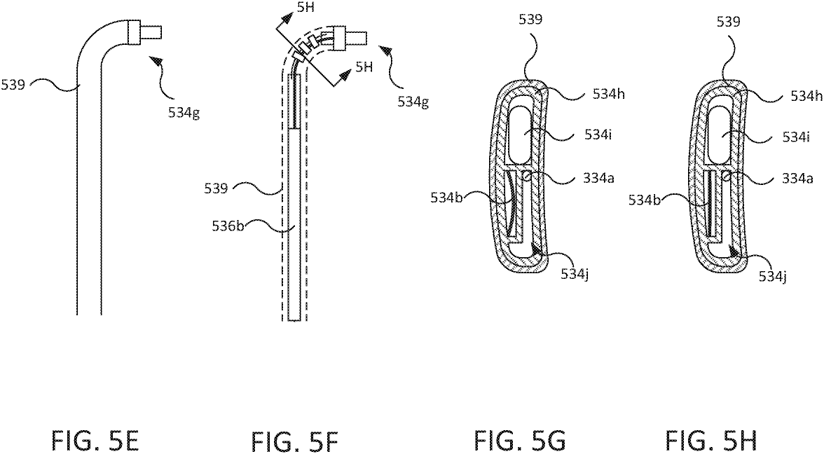

The two hinge portions 334 are provided on left and right sides (e.g., of the head of the user or the display assembly 110) and may also be referred to as a first and second hinge portions or left and right hinge portions. The two elongated portions 336 are provided on left and right sides (e.g., of the head of the user or the display assembly 110) and may be referred to as a first and second elongated portions or left and right elongated portions. Demarcations between the hinge portions 334, the elongated portions 336, and the strap portion 338 may be visible to the user (as represented by solid lines in the figures) or may not be visible (e.g., being hidden by an outer covering). The head support 130 may be configured in various different manners, for example, being removably or fixedly coupled to the display assembly 110, including electronic components, including speakers and audio tunnels for transferring sound from the speakers toward and/or away therefrom and/or relative to the ears of the user, removability of the strap portion 338, mechanisms for retaining the states or position of the head support 130, among others. The hinge portion 334, the elongated portion 336, and the strap portion 338 are discussed generally below with respect to FIGS. 3A-3B and with specific variations shown in FIGS. 4A-5H.

Each of the hinge portions 334 is coupled to and extends between one of the elongated portions 336 and the side portion 112b of the chassis 112. The hinge portion 334 is changeable (e.g., reconfigurable or movable) between an extended state and a collapsed state, thereby enabling the elongated portion 336 to pivot relative to the chassis 112 of the display assembly 110. In the extended states of the hinge portions 334, the elongated portions 336 extend rearward from the chassis 112 of the display assembly (e.g., to receive the head of the user therebetween) and may also be referred to as being in the extended states. In the collapsed states of the hinge portions 334, the elongated portions 336 extend laterally inward across at least a portion of a rearward side 112c of the display assembly 110 (e.g., rightward from a left one of the side portions 112b of the chassis 112 of the display assembly 110, and leftward from a right one of the side portions 112b) and may also be referred to as being in the collapsed states. The extended and collapsed states may also be referred to as extended and collapsed, deployed and stowed, or first and second positions or configurations.

The hinge portion 334 may, for example, provide an angular range of motion between the extended state and the collapsed state and, thereby, between the extended position and the collapsed position of the elongated portion 336. The angular range of motion may, for example, be between 70 and 110 degrees, for example, such as between 80 and 100 degrees. The hinge portion 334 may be configured to mechanically retain the elongated portion 336 in the extended position and/or the collapsed position, while permitting the elongated portion 336 to move generally freely therebetween. For example, greater force may be required to move the elongated portion 336 from (e.g., out of) the extended position, the collapsed position, or both, as compared to moving to into or between such positions. Various mechanical mechanisms for retaining the hinge portion 334 and the elongated portion 336 in the extended position are discussed in further detail below with respect to FIGS. 4A-4F (e.g., rotational cam surfaces that are axially pressed against each other) and with respect to FIGS. 5A-5H (e.g., a tape spring).

The hinge portion 334 may be configured for the elongated portion 336 to pivot relative to the chassis 112 in different manners. The hinge portion 334 may, for example, include a single-axis hinge that pivots about a single axis (e.g., as shown in FIGS. 4A-4F), a continuous hinge that bends continuously over a length of the hinge portion 334 as opposed to having discrete axes (e.g., as shown in FIGS. 5A-5H), a multi-axis hinge that pivots about multiple fixed axes, a linkage, or suitable combinations thereof. Hinges or other mechanisms of the hinge portion 334 may be arranged in various manners, for example, being hidden in one or more of the states (e.g., as shown in FIGS. 4A-5H), being embedded or otherwise covered in material (e.g., as shown in FIGS. 5A-5H), being exposed, being proud of adjacent inner surfaces of the chassis 112 and/or the head support 130, or being flush with adjacent inner surfaces of the chassis 112 of the display assembly 110 and/or the head support 130.

The hinge portion 334 may also be configured to transfer electrical power and/or signals between the electronics 116 of the display assembly 110 and the elongated portion 336 of the head support 130, such as with an electronic interconnect 334a (e.g., an audio interconnect) extending therethrough. The hinge portions 334 may be further configured to transfer sound waves from the elongated portion 336 (e.g., from speakers thereof) through a portion or entire length of the hinge portion 334 and/or to the display assembly 110, for example, including an audio back port tunnel, as discussed in further detail below with respect to FIGS. 4A-5H.

Each of the elongated portions 336, as referenced above, extends from the hinge portion 334 and is movable thereby between the extended position and the collapsed position. The elongated portion 336 includes or is configured as an elongated, rigid structure, such as a shell that contains other components (e.g., as shown in FIGS. 4A-4F) or may be configured as an internal chassis that is overmolded or otherwise covered with a softer material (e.g., as shown in FIGS. 5A-5H). The elongated, rigid structure may be generally rigid (e.g., so as to not itself deform under forces expected during normal usage) of the head-mounted display unit 100 and/or being less flexible than the strap portion 338. The elongated structure may be formed of a singular component or multiple components coupled to each other. The elongated portions 336 may also be referred to as arms, arm portions, arm segments, or rigid portions.

In the extended positions, the elongated portions 336 extend rearward from the chassis 112 and are spaced apart to receive the head of the user therebetween. In the collapsed positions, the elongated portions 336 extend laterally across at least part of the interior side of the display assembly 110. In the collapsed positions, the elongated portions may partially cover and protect the displays 114 and/or the optical components thereof (e.g., from impact or other contact therewith), as illustrated in FIG. 3B. The elongated portions 336 (e.g., the rigid structures thereof) may have a length that is less than half of a width of the display assembly 110, or have another suitable length, such that when in the collapsed positions, rearward ends of the elongated portions 336 of the head support 130 do not overlap each other and/or a lateral gap (e.g., measured left to right) is arranged therebetween, as illustrated in FIG. 3B. Configured with such a length, in the extended positions, the rear ends of the elongated structure of the elongated portions 336 may terminate at or forward of the ears 302 of the head 300 of the user, as shown in FIG. 3C. The elongated portions 336 (e.g., the rigid structures thereof) may, for example, be between one and four inches in length.

As referenced above, each of the elongated portions 336 may include the electronic components 336a, such as speakers, user sensors (e.g., physiological, such as heart rate or galvanic skin response sensors, movement sensors, electrodes), environment sensors (e.g., camera, ambient light sensors, microphones, position sensors), and/or power device (e.g., battery). In one example, as shown, the electronic components 336a include speakers, such as a low-range speaker 336a-1 (e.g., a woofer) and a high-range speaker 336a-2 (e.g., a tweeter). In the claims and the description that follow, the speakers may be identified numerically (e.g., first or second), directionally (e.g., by side of the head-mounted display unit 100), and/or by frequency range (e.g., low or high) to distinguish therebetween. As examples, those speakers on the left side of the head support 130 may be referred to as left speakers, first speakers, a left low-range speaker, a left high-range speaker, a first low-range speaker, a first high-range speaker, a first left speaker, or a second left speaker, while those speakers on the right side of the head support 130 may be referred to as right speakers, second speakers, a right low-range speaker, a right high-range speaker, a second low-range speaker, a second high-range speaker, a first right speaker, or a second right speaker.

The low-range speaker 336a-1 and the high-range speaker 336a-2 may be extra-aural speakers that are in communication with one or more audio tunnels that transmit sound from the speakers 336a-1, 336a-2 rearward and/or forward therefrom toward and/or away from ears (e.g., left and right ears) of the user. The audio tunnels, which are not shown or labeled in FIGS. 3A-3C), are hollow structures that extend through the elongated portions 336 and may further extend through the hinge portions 334. Outlets, such as a front port outlet 336b, of the audio tunnels may be positioned generally proximate the ears of the typical user (e.g., forward and/or upward thereof) but not on, over, or in the ears or ear canals of the users. Those audio tunnels that transmit sound toward the ear may be referred to as audio front port tunnels and away from the ear as audio back port tunnels. The audio tunnels may be identified numerically (e.g., first or second), directionally (e.g., by side of the head-mounted display unit 100), and/or by location (e.g., front being closer to the users ear or rear). For example, the audio tunnels may be identified as left audio tunnels, right audio tunnels, a left front port audio tunnel, a left rear port audio tunnel, a right front port audio tunnel, a right rear port audio tunnel, first audio tunnels, second audio tunnels, second front port audio tunnel, or a second rear port audio tunnel, as may be appropriate. The audio tunnels emit the sound waves into the environment (e.g., proximate or away from the ears of the user) through outlets at the end thereof. Further discussion of audio tunnels and outlets is provided below with respect to FIGS. 4A-5H.

The electronic components 336a (e.g., the low-range speaker 336a-1 and the high-range speaker 336a-2) are connected to the electronics 116 of the head-mounted display unit 100, such as to a printed circuit board 316e coupled to (e.g., contained in) the chassis 112 via the electronic interconnect 334a that extends through the hinge portion 334. The electronic interconnect 334a may include, for example, four conductors (e.g., power and ground conductors for each of the low-range speaker 336a-1 and the high-range speaker 336a-2), five conductors (e.g., adding a control wire), more or less. In the case of the elongated portion 336 including other electronic components 336a, the electronic interconnect 334a may include conductors in addition to those associated with the low-range speaker 336a-1 and the high-range speaker 336a-2 (e.g., for conducting power and/or signals to and/or from sensors and/or a power device). The elongated portions 336 may also include various ports and/or channels for transferring soundwaves therethrough and/or to other portions of the head support 130 and/or to the display assembly 110.

The strap portion 338 extends between the ends of the elongated portions 336 on each side of the left and right sides of the head support 130. The strap portion 338 is flexible substantially continuously across the length thereof between the two elongated portions 336, so as to conform to the head of the user. The strap portion 338 may also be elastic substantially continuously across the length thereof between the two elongated portions 336, so as to be in tension around the head of the user to draw the display assembly 110 toward the face of the user with the facial interface 120 compressed therebetween. For example, the strap portion 338 may be formed of a monolithic material that is flexible and elastic (e.g., a molded elastomer), such as silicone, rubber, other elastomer, a woven material having elastic properties, and/or woven materials having elastic material incorporated therein. The material forming the strap portion 338 may be referred to as an elastic material, a flexible material, or similar. The strap portion 338 may also include an internal material or structure having different material properties than the monolithic material, for example, having a higher tensile strength to reinforce the monolithic material forming an outer surface of the strap portion 338.

The strap portion 338 may be removably coupled to the elongated portions 336 (e.g., as shown in FIGS. 4A-4F) or may be irremovably coupled thereto (e.g., as shown in FIGS. 5A-5H, such as being integrally formed with outer surfaces of the elongated portions 336 and/or the hinge portions 334). The strap portion 338 may also be referred to as a strap, a flexible strap, an elastic strap, a band, a flexible band, or an elastic band.

Referring to FIGS. 4A-4F, a head support 430 is a variation of the head support 130. In the description of the head support 430 that follows, components and features of the head support 430 generally correspond to those of the head support 130 having like reference numerals in the tens and ones positions with further details thereof described. For example, the hinge portion 434 generally corresponds to the hinge portion 334.

The head support 430 generally includes, moving rearward relative to the display assembly 110, two hinge portions 434, two elongated portions 436, and a strap portion 438 extending between the elongated portions 436. The two hinge portions 434 and the two elongated portions 436 are arranged on left and right sides of the head of the user and of the display assembly and may be referred to as first and second or left and right hinge portions and elongated portions. As described in further detail below, the head support 430 may, but for the strap portion 438, have a generally rigid configuration. The hinge portions 434 define fixed, singular axes about which the elongated portions 436 pivot relative to the display assembly 110, while the elongated portions 436 may be generally rigid structures that generally do not bend or twist under normal loading while worn by the user. Further, the hinge portions 434 may be fixedly coupled to the display assembly 110 and the elongated portions 436 may be fixedly coupled to the hinge portions 434 to not be interchangeable or otherwise easily removable by a user. The strap portion 438 may be removably coupled to the elongated portions 436, so as to be easily removable and coupleable by a user, for example, to interchangeably couple different strap portions 438 thereto.

The hinge portion 434 of the head support 430 includes a hinge 434b that generally includes a front hinge segment 434c and a rear hinge segment 434d, which are pivotably coupled to each other to cooperatively define a singular pivot axis 434e (illustrated in heavy dash-dot lines) that may be vertical (as shown). For example, the front hinge segment 434c and the rear hinge segment 434d may be pivotably coupled with a hinge pin 434f (illustrated in dot-dot lines in FIG. 4C for ease of illustration). The front hinge segment 434c is fixedly coupled to the side portion 112b of the chassis 112 of the display assembly 110, for example, with threaded fasteners (shown; not labeled). The rear hinge segment 434d is fixedly coupled to the elongated portion 436 of the head support 430, for example, with threaded fasteners (shown; not labeled). The rear hinge segment 434d pivots relative to the front hinge segment 434c and, thereby, the chassis 112 about the singular pivot axis 434e between the extended state and the collapsed state. As shown, when in the extended state, the hinge 434b may be generally concealed from view, for example, being contained in recesses defined by the side portions 112b of the display assembly 110 and/or by the elongated portion 436 of the head support 430.

The hinge 434b may further be configured to mechanically retain the elongated portion 436 in the extended position and may be still further configured to mechanically retain the elongated portion 436 in the collapsed position. For example, the hinge 434b may include a rotational cam device 436f that mechanically retains the hinge 434b in and/or biases the hinge 434b into the extended position and/or the collapsed position. The rotational cam device 436f may be configured in any suitable manner, such as by including one or more axially biasing springs (e.g., Belleville springs and/or coil springs) that bias together two cam surfaces that are rotationally fixed to the front hinge segment 434c and the rear hinge segment 434d, respectively. The cam surfaces are illustrated schematically as a diagonal segment (relative to the singular pivot axis 434e) of the front hinge segment 434c.

An electronic interconnect 434a may also extend through the hinge portion 434. For example, in the case of the elongated portion 436 including the electronic components 336a (e.g., the low-range speaker 336a-1 and the high-range speaker 336a-2), the electronic interconnect 434a includes a suitable number of conductors for the electronic components 336a associated therewith (e.g., four or five, as referenced previously). The electronic interconnect 434a may, for example, extend through the hinge 434b coaxially with the singular pivot axis 434e, such as with an upper segment thereof extending through the elongated portion 436 and a lower segment thereof extending into the side portion 112b of the display assembly 110, or vice versa.

The elongated portion 436 of the head support 430 includes an outer chassis 436b and the electronic components 336a. The outer chassis 436b is a generally rigid structure that defines the overall shape of the elongated portion 436 and to which the electronic components 336a are coupled and/or positioned within. The outer chassis 436b may be a unitary or multi-piece structure, which may form the outer surface of the elongated portion 436 or may include an outer covering coupled thereto (e.g., paint, elastomer, or textile) whose shape is formed by or generally conforms to the shape of the outer chassis 436b. The outer chassis 436b may fixedly contain various other components therein (e.g., the electronic components 336a).

The electronic components 336a, such as one or more of the low-range speaker 336a-1 and the high-range speaker 336a-2 are positioned within (e.g., contained in) a cavity defined by the outer chassis 436b. As shown, the low-range speaker 336a-1 is positioned forward of the high-range speaker 336a-2. The elongated portion 436 further includes an audio front port 436c that is the audio channel through which sound waves are transmitted from one or more the low-range speaker 336a-1 and/or the high-range speaker 336a-2 toward the ear of the user for listening thereto. As shown, the audio front port 436c extends rearward and/or downward from the low-range speaker 336a-1 and the high-range speaker 336a-2 to an outlet 436d in a lower and/or inward side of the elongated portion 436 of the head support 430, which is to be positioned proximate the ear of the user, for example, forward and/or above the ear canal. The elongated portion 436 further includes audio back port tunnel 436e that is a channel through which sound waves are transmitted from the low-range speaker 336a-1 away from the ear of the user to function, for example, as a bass reflex port. The audio back port tunnel 436e may additionally extend to and/or through the hinge portion 434 and/or to the side portion 112b of chassis 112 of the display assembly 110.

As referenced above, the rear hinge segment 434d of the hinge 434b is fixedly coupled to the elongated portion 436 of the head support 430 and, in particular, to a forward end 436g of the elongated portion 436, such as with threaded fasteners or other fasteners (shown; not labeled). The forward end 436g of the elongated portion 436 may further define a recess in which is received the hinge 434b when in the extended configuration.

A rear end 436h of the elongated portion 436 of the head support 430 is coupled to the strap portion 438 of the head support 430. As referenced above, the elongated portion 436 may have a length such that the rear end 436h is positioned forward of the ear of typical users (e.g., adults). Further, the lengths of the elongated portions 436 may be cooperatively configured such that when in the collapsed positions the rear ends 436h thereof are spaced apart laterally, for example, such that the rear ends 436h extend toward each other but do not contact or otherwise overlap each other in the lateral direction.

The strap portion 438, as described previously, is a flexible and elastic structure that is removably coupleable to and extends between the rear ends 436h of the two elongated portions 436 of the head support 430. The strap portion 438 extends rearward from the rear ends 436h of the elongated portions 436 of the head support 430 above the ears and around the head of the user. As noted above, the rear ends 436h of the elongated portions of the head support 430 may be spaced apart and may be further cooperatively configured with the strap portion 438 such that rigid components associated with the elongated portions 436 of the head support 430 do not engage or otherwise interfere with each other in the collapsed state.

In one example, the strap portion 438 is interchangeably coupleable to the rear end 436h of the elongated portion 436, such that a user may easily remove and couple different ones of the strap portions 438 to the elongated portions 436. The rear end 436h may be cooperatively configured with the strap portion 438 to couple therewith in different manners, for example, defining an aperture through which the strap portion 438 is received, hook and loop fasteners, snaps, magnets, other male/female coupling interface, still other types of coupling interfaces, or suitable combinations thereof.

Referring to FIGS. 5A-5H, a head support 530 is a variation of the head support 130. In the description of the head support 530 that follows, components and features of the head support 530 generally correspond to those of the head support 130 having like reference numerals in the tens and ones positions with further details thereof described. For example, the hinge portion 534 generally corresponds to the hinge portion 334.

The head support 530 generally includes, moving rearward relative to the display assembly 110, hinge portions 534 on left and right sides, elongated portions 536 on the left and right sides, and a strap portion 538 extending between the elongated portions 536. As described in further detail below, the head support 530 may have a generally soft and/or flexible configuration. The hinge portions 534 may be configured to allow some conformance (e.g., twisting) while in the extended positions and is configured to bend over its length (e.g., as opposed to a single pivot axis). Various mechanical and/or electrical components of the hinge portions 534 and the elongated portions 536 may be covered by, for example being molded into, a cover material 539 that forms the outer surfaces thereof. The cover material 539 is a soft touch and elastic material (e.g., silicone) that additionally forms the strap portion 538 and extends continuously (e.g., as a singularly-formed component) between the side portions 112b of the chassis 112 of the display assembly 110. Further, the hinge portions 534 may be removably coupleable to the display assembly 110, such that a user may easily remove and couple the head support 530 or different ones of the head support 530 to the display assembly 110.

The hinge portion 534 of the head support 530 includes a tape spring 534b that forms a hinge by bending over its length, as opposed to a single axis, thereby allowing the elongated portion 536 to pivot relative to the display assembly 110 between the extended and collapsed states. The tape spring 534b is a thin-walled, sprung tape having a curved cross-sectional shape with an inner face 534c-1 of the tape spring 534b being convex and an outer face 534c-2 of the tape spring 534b being concave when in the extended state. The tape spring 534b may have a generally constant thickness. The curved cross-sectional shape may be that of a circular arc. The tape spring 534b is elongated, extending over its length between a forward end 534d and a rearward end 534f. The forward end 534d is fixedly coupled to a connector 534g by which the head support 530 is removably coupleable to the chassis 112 of the display assembly 110 (e.g., with any suitable coupling mechanism, such as a latch mechanism). The rearward end 534f is fixedly coupled to a component of the elongated portion 536 of the head support 530. The tape spring 534b may be formed of any suitable material, such as a metal, polymer, or composite.

The tape spring 534b is considered to be in a deployed state when extending straight (e.g., linearly) from the forward end 534d to the rearward end 534f. The tape spring 534b is considered in a stowed state when the forward end 534d and the rearward end 534f of the tape spring 534b are biased toward each other, thereby bending (e.g., folding or rolling) the tape spring 534b along its length. For example, in the stowed state, the forward end 534d and the rearward end 534f are biased toward each other such that different portions of the inner face 534c-1 (e.g., the convex face) are moved toward and/or face toward each other. It should be noted that while the deployed state occurs in a single orientation (i.e., with the tape spring 534b extending straight between the forward end 534d and the rearward end 534f thereof), the stowed state may occur in multiple orientations (e.g., over an angular range) that is biased away from (e.g., does not include) the stowed state.

The tape spring 534b mechanically retains itself (e.g., locks) in the deployed stated, thereby requiring application of a threshold torque to be moved from the deployed state to the stowed state. Accordingly, the tape spring 534b may function to mechanically retain the head support 530 (e.g., the elongated portions 536 thereof) in the extended positions. The tape spring 534b may be further configured to, while in the stowed state, either output negligible torque (e.g., no torque) such that the tape spring 534b does not bias itself from the stowed state toward or away from the deployed state, or output torque that biases the tape spring 534b away from the deployed state (e.g., toward the rearward side 112c).

The hinge portion 534 may further include ribs 534h (three shown; one labeled), which are members that are coupled the tape spring 534b and support the cover material 539 thereover. Each of the ribs 534h has an outer cross-sectional shape with a height and a width that are greater than a height and the thickness of the tape spring 534b, respectively. Each of the ribs 534h is further coupled to the tape spring 534b, such that the outer cross-sectional shape extends above and below the tape spring 534b and may further extend laterally outward and/or inward of the tape spring 534b. An internal cross-sectional shape of the ribs 534h may be generally open with one or more voids 534j (e.g., apertures) through which extend the tape spring 534b, the electronic interconnect 534a, and an audio back port tunnel 534i (discussed further below). Each of the ribs 534h additionally has a thickness extending the direction of the length of the tape spring 534b, and the ribs are 534b are spaced apart along the length of the tape spring 534b. The thickness and the spacing of the ribs 534h are cooperatively configured to permit the tape spring 534b to bend into the collapsed state. The thickness and the spacing of the ribs 534h may be further configured to limit rotation of the hinge portion 534 toward the display assembly 110, for example, with adjacent ribs interfering (e.g., engaging each other) or the cover material 539 being compressed therebetween. The ribs 534h may have the same outer and inner cross-sectional shapes and/or dimensions as each other. The ribs 534h may be made of any suitable material according any suitable process, such as being injection molded or extruded and cut plastic components.

The electronic interconnect 534a may also extend through the hinge portion 534. For example, in the case of the elongated portion 536 including the electronic components 336a (e.g., the low-range speaker 336a-1 and the high-range speakers 336a-2), the electronic interconnect 534a includes a suitable number of conductors for the electronic components 336a associated therewith (e.g., four or five, as referenced previously). The electronic interconnect 534a may, for example, extend through the voids 534j of the ribs 534h. The electronic interconnect 534a may extend along the length of the tape spring 534bs, for example along an edge or surface of the tape spring 534b, thus being straight when the tape spring 534b is in the extended state and following the curvature of the tape spring 534b when in the collapsed state.

The audio back port tunnel 534i is a channel through which soundwaves from the low-range speaker 336a-1 and/or the high-range speaker 336a-2 are transmitted away from the ear of the user. The audio back port tunnel 534i may be formed, for example, by a flexible tubular conduit that extends along the length of the tape spring 534b forward and/or upward from the low-range speaker 336a-1. The audio back port tunnel 534i may, thus, be straight when the tape spring 534b is in the extended state and following the curvature of the tape spring 534b when in the collapsed state. The audio back port tunnel 534i is coupled to the ribs 534h, for example, extending through the voids 534j therein.

As referenced above, the forward end 534d of the tape spring 534b is fixedly coupled to a connector 534g, for example, with threaded fasteners. The connector 534g is configured to removably couple to the side portion 112b of the chassis 112 of the display assembly 110. For example, the connector 534g may be a male component that is insertable into a latch mechanism of the chassis 112 that is operably to releasably couple to the connector 534g. The connector 534g may be further configured to electrically couple the electronic interconnect 534a to the display assembly 110 (e.g., the printed circuit board 316e thereof), for example, having discrete electrical contacts that are each associated with one of the conductors of the electronic interconnect 534a.

As referenced above, the rearward end 534f of the tape spring 534b is fixedly coupled to a structural component of the elongated portion 536 of the head support 530, which as discussed in further detail below, may be one of the rearward electronic components 336a or an internal chassis to which the rearward electronic components 336a are coupled.

As referenced above, the ribs 534h support the cover material 539 thereof, which cooperatively form the cross-sectional shape of the hinge portion 534. For example, the cover material 539 may be an elastomeric material (e.g., silicone) that is overmolded to the rib 534h and underlying components (e.g., the tape spring 534b, the electronic interconnect 534a, the audio back port tunnel 534i, and part of the connector 534g). The cover material 539 may further fill various voids 534j in each of the ribs 534h and the spacing between the ribs 534h. As referenced above and as described in further detail below, the cover material 539 may be substantially continuous (e.g., unitary or monolithically formed) over both hinge portions 534, both elongated portions 536, and the strap portion 538.

The elongated portion 536 of the head support 530 generally includes the electronic components 336a (e.g., the low-range speaker 336a-1, and the high-range speaker 336a-2) and a chassis 536b, which are covered by the covering material 539. The chassis 536b is a generally rigid structure extending from a front end (not labeled; coinciding with the rear end 534e of the tape spring 534b) thereof to a rear end 536d thereof. The chassis 536b is coupled to the low-range speaker 336a-1 and the high-range speaker 336a-2. The chassis 536b may be a separate component or be integrally formed with the low-range speaker 336a-1, for example, forming a chamber and/or audio tunnels, such as an audio front port tunnel 536f having an outlet 536g and an audio back port tunnel 536h to which is coupled the audio back port tunnel 534i of the hinge portion 534 (e.g., being in communication and/or formed integrally with the audio back port tunnel 534i, such as being a common flexible tube). The high-range speaker 336a-2 may be positioned forward of the low-range speaker 336a-1 (as shown), or vice versa. The outlet 536g is positioned proximate to the ear of the user (e.g., forward and above the ear canal) through which sound waves are emitted to be listed to by the user.

The chassis 536b extends a length between the forward end and the rearward end 536d thereof (e.g., of the elongated portion 536). The forward end 534d is fixedly coupled to the tape spring 534b, for example, with threaded fasteners (shown; not labeled). The rearward end 536d of the chassis 536b may generally form the rearward end 536e of the elongated portion 536. When in the extended position, the rearward end 536d may be positioned forward of the ear of the user. When in the collapsed position, the rearward ends 536e of the elongated portions 536 are spaced apart laterally, for example, such that the rear ends 536e extend toward each other but do not contact or otherwise overlap each other in the lateral direction.

The elongated portion 536 is covered by the cover material 539, for example, with the cover material 539 being formed around the chassis 536b and the electronic components 336a (e.g., the low-range speaker 336a-1 and the high-range speaker 336a-2). The cover material 539 of the elongated portion 536 is formed continuously with the cover material 539 of the hinge portion 534.

As referenced above, the strap portion 538, is a flexible and elastic component that is formed continuously with the cover material 539 of the hinge portion 534 and the elongated portion 536 of the head support 130. For example, the material forming the strap portion 538 and the cover material 539 is formed monolithically during a singular molding operation. Thereby, the material (e.g., the flexible material, such as silicone) forms the cover material 539 and the outer surfaces over the hinge portions 534 and the elongated portions 536, as well as the strap portion 538.

What is claimed is:

1. A head-mounted display comprising:
a display assembly having a display for outputting graphical content to a user; and
a head support coupled to the display assembly and configured to support the display assembly on a head of the user, the head support comprising:
a first hinge portion coupled to a first side of the head-mounted display and a second hinge portion coupled to a second side of the head-mounted display, each of the first hinge portion and the second hinge portion being movable between a first state and a second state;
a first elongated portion coupled to the first hinge portion and a second elongated portion coupled to the second hinge portion, each of the first elongated portion and the second elongated portion being rigid and movable with the first hinge portion and the second hinge portion, respectively, between the first state and the second state; and
a strap portion coupled to and extending between the first elongated portion and the second elongated portion, the strap portion being flexible and elastic;
wherein each of the first elongated portion and the second elongated portion, when in the first state, extend rearward from the head-mounted display and, when in the second state, extend along a rearward side of the display assembly toward each other and do not overlap each other.

2. The head-mounted display according to claim 1, wherein when the first hinge portion and the second hinge portion are in the first state and the head-mounted display is worn on the head of the user, the strap portion extends over ears of the user;
wherein the first elongated portion contains a first speaker, and the second elongated portion contains a second speaker;
wherein the first elongated portion includes a first audio back port tunnel for emitting sound away from the user, the first audio back port tunnel extending forward and upward relative to the first speaker;
wherein the second elongated portion includes a second audio back port tunnel for emitting sound away from the user, the second audio back port tunnel extending forward and upward relative to the second speaker; and
wherein the first hinge portion and the second hinge portion are each mechanically retained in the first state by way of a tape spring or cam device.

3. The head-mounted display according to claim 1, wherein when the first hinge portion and the second hinge portion are in the first state and the head-mounted display is worn on the head of the user, the strap portion extends over ears of the user.

4. The head-mounted display according to claim 3, wherein when the first hinge portion and the second hinge portion are in the first state and the head-mounted display is worn on the head of the user, rearward ends of each of the first elongated portion and the second elongated portion terminate forward of one of the ears of the user.

5. The head-mounted display according to claim 3, wherein the first elongated portion includes a first speaker, and the second elongated portion includes a second speaker.

6. The head-mounted display according to claim 5, wherein the first elongated portion contains the first speaker, and the second elongated portion contains the second speaker.

7. The head-mounted display according to claim 6, wherein the first elongated portion includes a first outlet for emitting sound from the first speaker to a first of the ears of the user, the first outlet being positioned proximate to, forward of, and above the first of the ears; and
wherein the second elongated portion includes a second outlet for emitting sound from the second speaker to a second of the ears the user, the second outlet being positioned proximate to, forward of, and above the second of the ears.

8. The head-mounted display according to claim 7, wherein the first elongated portion includes a first audio back port tunnel for emitting sound away from the user, the first audio back port tunnel extending forward and upward relative to the first outlet; and
wherein the second elongated portion includes a second audio back port tunnel for emitting sound away from the user, the second audio back port tunnel extending forward and upward relative to the second outlet.

9. The head-mounted display according to claim 5, wherein the first elongated portion includes a first audio back port tunnel for emitting sound away from the user, the first audio back port tunnel extending forward and upward relative to the first speaker; and
wherein the second elongated portion includes a second audio back port tunnel for emitting sound away from the user, the second audio back port tunnel extending forward and upward relative to the second speaker.

10. The head-mounted display according to claim 9, wherein the first audio back port tunnel extends at least partially through the first hinge portion, and the second audio back port tunnel extends at least partially through the second hinge portion.

11. The head-mounted display according to claim 10, wherein the head support further includes electronic components and an electronic interconnect that extends between the electronic component and a printed circuit board of the display assembly, the electronic interconnect extending through one of the first hinge portion or the second hinge portion.

12. The head-mounted display according to claim 1, wherein the first hinge portion and the second hinge portion are each mechanically retained in the first state.

13. The head-mounted display according to claim 12, wherein the first hinge portion and the second hinge portion are each mechanically retained in the first state by way of a tape spring or cam device.

14. A head-mounted display comprising:
a display assembly having an electronic display;
a head support coupled to the display assembly for supporting the display assembly on a head of a user, the head support comprising:
first and second hinge portions that each include a tape spring that is movable between a deployed state extending rearward relative the head-mounted display and a stowed state extending laterally across an inner face of the head-mounted display; and a flexible band coupled to the first and second hinge portions.

15. The head-mounted display according to claim 14, wherein the head support further comprises first and second rigid portions that are more rigid than the flexible band and extend between the first and second hinge portions, respectively, and the flexible band;
wherein when each of the first and second hinge portions are in the stowed state, the first and second rigid portions extend toward each other with a gap therebetween;
wherein first and second rigid portions each include a speaker;
wherein a flexible material integrally forms the flexible band and outer surfaces of the first and second hinge portions, the flexible material being a molded elastomer; and
wherein each of the first and second hinge portions further include ribs that are coupled to and spaced apart along the tape spring, the flexible material being molded over the ribs of each of the first and second hinge portions.

16. The head-mounted display according to claim 14, wherein the head support further comprises first and second rigid portions that are more rigid than the flexible band and extend between the first and second hinge portions, respectively, and the flexible band.

17. The head-mounted display according to claim 16, wherein when each of the first and second hinge portions are in the stowed state, the first and second rigid portions extend toward each other with a gap therebetween.

18. The head-mounted display according to claim 16, wherein first and second rigid portions each include a speaker.

19. The head-mounted display according to claim 18, wherein a flexible material integrally forms the flexible band and outer surfaces of the first and second hinge portions and the first and second rigid portions.

20. The head-mounted display according to claim 14, wherein a flexible material integrally forms the flexible band and outer surfaces of the first and second hinge portions, the flexible material being a molded elastomer.

21. The head-mounted display according to claim 20, wherein each of the first and second hinge portions further include ribs that are coupled to and spaced apart along the tape spring, the flexible material being molded over the ribs of each of the first and second hinge portions.

22. A head-mounted display comprising:
a display assembly having a chassis and a display coupled to the chassis;
a facial interface coupled to the display assembly and configured to engage a face of a user for supporting the display assembly thereon;
a head support coupled to the display assembly and configured to engage a head of the user for supporting the display assembly thereon, the head support comprising:
left and right hinges coupled to left and right sides of the chassis of the display assembly;
left and right elongated portions coupled to and movable by the left and right hinges, respectively, between extended states and collapsed states, the left and right elongated portions extending rearward relative to the chassis in the extended states and extending laterally across an inner face of the display assembly in the collapsed state;
left and right speakers contained within the left and right elongated portions, respectively;
audio tunnels contained in the left and right elongated portions that transmit sound from the left and right speakers both forward and rearward thereof; and
a flexible strap coupled to and extending between the left and right elongated portions.

23. The head-mounted display according to claim 22, wherein the audio tunnels include a first left audio tunnel that transmits sound rearward from the left speaker, a second left audio tunnel that transmits sound forward from the left speaker, a first right audio tunnel that transmits sound rearward from the right speaker, and a second right audio tunnel that transmits sound forward from the right speaker.

24. The head-mounted display according to claim 23, wherein the first left audio tunnel includes a left outlet from which sound is emitted from the left speaker, the first right audio tunnel include a right outlet from which sound is emitted from the right speaker, the left outlet and the right outlet being positioned forward of and above left and right ears, respectively, of the user when the head-mounted display is worn thereby.
